(19) United States
(12) Patent Application Publication
(10) Pub. No.: US 2009/0303643 A1
(43) Pub. Date: Dec. 10, 2009

(54) SURGE PROTECT CIRCUIT

(76) Inventors: Yen-Wei Hsu, (US); Whei-Chyou Wu, Fremont, CA (US)

Correspondence Address: Yen-Wei Hsu, 7F No. 58, Jhouzih St.,Neihu District,, Taipei, 11459, TW

(21) Appl. No.: 12/136,062

(22) Filed: Jun. 10, 2008

(51) Int. Cl. H02H 9/00; H01G 4/008

(52) U.S. Cl. 361/54; 361/305

(57) ABSTRACT

The present invention relates to a solution to the unpredictable, inrush voltage or current surge such as static electricity and eddy current phenomenon. The solution provides a circuit which can guide an unpredictable voltage or current surge into the circuit and let them dissipate in the circuit. The present invention also relates to a solution to a DC power source surge. The solution provides a protection circuit to divide an input power surge into DC and AC in which AC will be dissipated in the protection circuit and the safe DC is sent to the output. The present invention further relates to an energy discharge capacitor which can quickly dissipate the charge and the capacitor can be applied to our inventive circuits.

### TECHNICAL FIELD OF THE INVENTION

The present invention relates to a solution to the unpredictable, inrush voltage or current surge such as static electricity and eddy current phenomenon. The solution provides a circuit which can guide an unpredictable voltage or current surge into the circuit and let them dissipate in the circuit. The present invention also relates to a solution to a DC power source surge. The solution provides a protection circuit to divide an input power surge into DC and AC in which AC will be dissipated in the circuit and the safe DC is sent to the output. The present invention further relates to an energy discharge capacitor which can quickly dissipate the charge and the capacitor can be applied to our inventive circuits.

### BACKGROUND OF INVENTION

More electronic devices have been invented and they have been used in many different fields and applications. A lot of critical problems still exist in the devices and can't be solved for quite long time. Those problems include accumulated heat, noise and low sensitivity which will cause the devices and systems unstable. The present invention can benefit the devices and systems with some advantages:
(1) Thermo issues are massively reduced.
(2) The noise problems are significantly neutralized.
(3) The new devices and systems are more sensitive and reliable.
(4) The new devices and systems can get highly dynamic response and broadening bandwidth.
(5) The new devices and systems are potentially scalable.

The background of the invention is introduced by beginning from mathematical model and through some representative devices and circuits. First, the Cauchy-Riemann equations are used to describe a system's impedance behaviors. Consider the impedance z in the complex form of

z=F(i,v)+jG(i.v) (1)

where i, v are current and voltage respectively. Assumed that the functions F(i,v) and G(i.v) are analytic in the specific domain, from the Cauchy-Riemann equations as following

$$\begin{matrix}\frac{\partial F}{\partial i} = \frac{\partial G}{\partial v} \\ and & ( 2 ) \\ \frac{\partial F}{\partial v} = - \frac{\partial G}{\partial i} & ( 3 )\end{matrix}$$

Using the chain rule, we further obtain from the equations (2) and (3)

$$\begin{matrix}\frac{\partial F}{\partial ω} \frac{\partial ω}{\partial i} = \frac{\partial G}{\partial ω} \frac{\partial ω}{\partial v} \\ and & ( 4 ) \\ \frac{\partial F}{\partial ω} \frac{\partial ω}{vi} = - \frac{\partial G}{\partial ω} \frac{\partial ω}{\partial i} & ( 5 )\end{matrix}$$

where the variable ω may be the frequency, temperature, magnetic flux density, optical intensity and so on. Let the terms

$$\begin{matrix}\{ \begin{matrix}\frac{\partial ω}{\partial i} > 0 \\ \frac{\partial ω}{\partial v} > 0\end{matrix} \\ or & ( 6 ) \\ \{ \begin{matrix}\frac{\partial ω}{\partial i} < 0 \\ \frac{\partial ω}{\partial v} < 0\end{matrix} & ( 7 )\end{matrix}$$

be non-zero and the same sign. Under the same sign conditions as the equation (6) or (7), from the equations (4) and (5),

$$\begin{matrix}\frac{\partial F}{\partial ω} > 0 \\ and & ( 8 ) \\ \frac{\partial F}{\partial ω} < 0 & ( 9 )\end{matrix}$$

should be held simultaneously. Equation (8) expresses the slope of impedance function a positive value which is called Positive Differential Resistivity or simply in short as PDR. Equation (9) expresses the slope of impedance function a negative value which is called Negative Differential Resistivity or simply in short as NDR. From the point of view of making a power source, the simple way to perform equation (6) and (7) is using the pulse-width modulation (PWM) method. The further meaning of equation (6) and (7) is that using the variable frequency c in pulse-width modulation to current and voltage is the most straightforward way, i.e.,

$$\{ \begin{matrix}\frac{\partial ω}{\partial i} \neq 0 \\ \frac{\partial ω}{\partial v} \neq 0\end{matrix}$$

In nature,

$$\frac{\partial F}{\partial ω} and \frac{\partial G}{\partial ω}$$

are positive or in general, under the condition like as the (9.1)

$$\frac{\partial F}{\partial ω} \frac{\partial G}{\partial ω} > 0 \qquad ( 9.1 )$$

Putting equation (9.1) into (4) and (5), we obtain

$$\frac{\partial ω}{\partial i} \frac{\partial ω}{\partial v} < 0 \qquad ( 9.2 )$$

Surprisingly, we can find a negative slope in the I-V curve of some special fiber-carbon materials

$$\frac{d V}{d I} = - R$$

or in parameter form

$$\frac{\frac{d V}{d ω}}{\frac{d I}{d ω}} = - R$$

where the resistance R is a positive value,

$$R > 0$$

$$or$$

$$\frac{d V}{d ω} \frac{d I}{d ω} < 0$$

also its equivalent form

$$\frac{d ω}{d V} \frac{d ω}{d I} < 0$$

The negative sign contributed from the current or voltage has a backward direction with respect to input current I or voltage V. In particular, this reverse current (−I) is to be called “back flow current.” Considering a semiconductor case is setting the voltage to be a multi-frequency pattern as

$$v ( t ) = {\sum }_{i = 0}^{∞} {v}_{i} ( {ω}_{0} , {ω}_{1} , … ) {e}^{j ( {ω}_{i} t + {φ}_{i} )} \qquad ( 9.3 )$$

which is produced by the PWM controller in the power source and its corresponding current is

$$i ( t ) = {I}_{0} ( {e}^{( \frac{q {\sum }_{i = 0}^{∞} {v}_{i} ( {ω}_{0} , {ω}_{1} , … ) {e}^{j ( {ω}_{i} t + {φ}_{i} )}}{kT} )} - 1 ) \qquad ( 9.4 )$$

where q (Coulomb) is the elementary charge,

q=1.602×10⁻¹⁹(C)

$$k ( \frac{Joule}{K °} )$$

is the Boltzmann constant,

k=1.380×10⁻²³

T(K°) is the absolute temperature of the P-N junction.

After obtaining the qualitative behaviors of PDR and NDR expressed by the equations (8) and (9) above, now we further look their quantitative behaviors. In theory, for a closed loop whose impedance is in the form of the equation (1) can be analogical to a simple parallel oscillator shown in FIG. 4 or a simple series oscillator shown in FIG. 5 of which both correspond to a 2^{nd}-order differential equation shown respectively by the equation (12) or (15). Please refer to some references [13, Vol 2, Chapter 8,9,10,11,22,23], [7, Page 173], [2, Page 181], [8, Chapter 10] and [6, Page 951-968]. First, a simple parallel oscillator has been shown in FIG. 4. Let the current iₗ and voltage v_{C} be replaced by x, y respectively. From the Kirchhoff 's Law, this simple oscillator is expressed as the form of

$$\begin{matrix}L \frac{d x}{d t} = y & ( 10 ) \\ C \frac{d y}{d t} = - x + {F}_{p} ( y ) & ( 11 )\end{matrix}$$

or in matrix form

$$[ \begin{matrix}\frac{d x}{d t} \\ \frac{d y}{d t}\end{matrix} ] = [ \begin{matrix}0 & \frac{1}{L} \\ - \frac{1}{C} & 0\end{matrix} ] [ \begin{matrix}x \\ y\end{matrix} ] + [ \begin{matrix}0 \\ \frac{{F}_{p} ( y )}{C}\end{matrix} ] \qquad ( 12 )$$

where the function F(y) represents the generalized Ohm's law and for the single variable case, Fₚ(y) is the real part function of the impedance function shown by the equation (1). “p” here stands for “parallel” oscillator. Furthermore, the equation (12) is a Liénard system which will be explained later. If taking the linear from of Fₚ(y),

Fₚ(y)=Ky

and K>0, it is a normally linear Ohm's law. Also, the state-equation of a simple series oscillator shown in FIG. 5 is

$$\begin{matrix}L \frac{d x}{d t} = y - {F}_{s} ( x ) & ( 13 ) \\ C \frac{d y}{d t} = - x & ( 14 )\end{matrix}$$

Or in the matrix form,

$$[ \begin{matrix}\frac{d x}{d t} \\ \frac{d y}{d t}\end{matrix} ] = [ \begin{matrix}0 & \frac{1}{L} \\ - \frac{1}{C} & 0\end{matrix} ] [ \begin{matrix}x \\ y\end{matrix} ] + [ \begin{matrix}- \frac{{F}_{s} ( x )}{L} \\ 0\end{matrix} ] \qquad ( 15 )$$

Where i_{C}, vₗ are replaced by x, y respectively. The function Fₛ(x) indicates the generalized Ohm's law, and, for the single variable case, fₛ(x) is the real part of the impedance function shown by the equation (15). Here “s” stands for “series” oscillator. Further, the equation (15) is the Lienard system too. Again, considering one system as shown by the equation (15), let L, C be to one, then the system becomes the form of

$$[ \begin{matrix}\frac{d x}{d t} \\ \frac{d y}{d t}\end{matrix} ] = [ \begin{matrix}y \\ - x + {F}_{p} ( y )\end{matrix} ] \qquad ( 16 )$$

To obtain the equilibrium point of the systems by the equations (15) and (16), setting the right hand side of the equations (15) and (16) to zero

$$\{ \begin{matrix}0 = y \\ 0 = - x + {F}_{p} ( y )\end{matrix} \\ \{ \begin{matrix}0 = y - {F}_{s} ( x ) \\ 0 = - x\end{matrix}$$

where Fₚ(0) and Fₛ(0) are the values of the generalized Ohm's law at zero. The gradient of equation (16) is

$$[ \begin{matrix}{F}_{s}^{′} ( 0 ) & 1 \\ - 1 & 0\end{matrix} ]$$

Let the slope of the generalized Ohm's law F′ₛ(0) be a new function as ƒₛ(0)

ƒₛ(0)≡F′ₛ(0)

the correspondent eigenvalues λ^{s}₁₂ are as

$${λ}_{1 , 2}^{s} = \frac{1}{2} [ - {f}_{s} ( 0 ) \pm \sqrt{{( {f}_{s} ( 0 ) )}^{2} - 4} ]$$

Similarly, in the simple parallel oscillator shown by the equation (12),

ƒₚ(0)≡F′ₚ(0)

the equilibrium point of the equation (12) is set to (Fₚ(0),0) and the gradient of the equation (12) is

$$[ \begin{matrix}0 & 1 \\ - 1 & {f}_{p} ( 0 )\end{matrix} ]$$

the correspondent eigenvalues λ^{p}_{1,2} are

$${λ}_{1 , 2}^{p} = \frac{1}{2} [ {f}_{p} ( 0 ) \pm \sqrt{{( {f}_{p} ( 0 ) )}^{2} - 4} ]$$

The qualitative properties of the systems shown by the equations (12) and (15), referred to [6] and [8], are as the following:
1. ƒₛ(0)>0, or ƒₚ(0)<0, its correspondent equilibrium point is a sink.
2. fₛ(0)<0, or fₚ(0)>0, its correspondent equilibrium point is a source.
   Thus, observing the above definitions of sink and source, a positive value of the slope value of impedance function Fₛ(x) or ƒₛ(x), or, a positive value of the slope of impedance function Fₚ(y), or ƒₚ(y) are called “positive differential resistivity” or simply “PDR“. They are shown by the equations (17) and (18) respectively below. If the value of derivative of the impedance function of any device or assembly is larger than zero, we can call the device or assembly presenting PDR property in the present invention.

Fₛ′(x)=ƒₛ(x)>0 (17)

or

Fₚ′(y)=ƒₚ(y)>0 (18)

On the contrary, a negative value of the slope value of impedance function Fₛ(x) or ƒₛ(x), or, a negative value of the slope of impedance function Fₚ(y), or ƒₚ(y) are called “negative differential resistivity” or simply “NDR”. They are shown by the equations (19) and (20) respectively below. If the value of derivative of the impedance function of any device or assembly is smaller than zero, we can call the device or assembly presenting NDR property in the present invention.

Fₛ′(x)=ƒₛ(x)<0 (19)

or

Fₚ′(y)=ƒₚ(y)<0 (20)
3. if ƒₛ(x)=0, or ƒₚ(y)=0 shown by the equations (21) and (22), its correspondent equilibrium point is a bifurcation point. Please referred to [9, Page 433], [10, Page 26] and [8. Chapter 10].

Fₛ′(x)=ƒₛ(x)=0 (21)

or

Fₚ′(y)=ƒₚ(y)=0 (22)

Semiconductor devices are widely used in many applications and the behaviors of their impedance function are worth noticing. Now a superconductor Josephson junction device has been introduced in some books as [4, Chapter 2, 3, 4, 5], [13, Vol. 3, Section 14.4], [12, section 4.6] and also referred by the invention describing Josephson junction device. Josephson junction device is discussed here because it has been well modeled and analyzed, and, the device is a representative of semiconductor P-N junction which is widely seen in many semiconductor devices. The behavior of semiconductor P-N junction is very dynamical and is hard to predict. This weak coupling exists in the junction causes the devices a lot of problems such as thermo heat, noise and low sensitivity, etc. Those problems are seen in almost all the semiconductor devices such as in solar cells, Hall sensors, ICs, IGBTs, Thyristors, CPUs, DSPs, ASICs, IPMs, MOSFETs, SCRs, CCD, LEDs, transistors, laser diodes and diodes, dielectric resonator antenna (DRA), digital controllers or micro controllers, transmission lines and waveguides, fiber communication devices, data buses, sodium lamps, mercurial bulbs, etc. and they will eventually cause the devices and systems unstable or overheated.

A superconducting Josephson junction device is an equivalent circuit can be modeled as a simple parallel oscillator expressed by the equation (12). More detailed of Josephson junction device can be referred by some books [4, Chapter 2,3,4,5], [12, Section 4.6].

Now we are going to find out what kind of conditions are needed for a system to be stabilized. Lienard theorem is helpful to explain this. Taking the system as expressed by the equation (12) or (15) is treated as a nonlinear dynamical system, we can extend these systems to be a well-known result on the existence of the limit cycle, referred to [11, Page 253-260], [10, Page 402-407], for a dynamical system as the form of

$$\{ \begin{matrix}\frac{d x}{d t} = y - F ( x ) \\ \frac{d y}{d t} = - g ( x )\end{matrix} \qquad ( 23 )$$

under certain conditions on the functions F and g. Or its equivalent form of a nonlinear dynamics from the equation (23) as

$$\frac{{d}^{2} x}{d {t}^{2}} + f ( x ) \frac{d x}{d t} + g ( x ) = 0 \qquad ( 24 )$$

where the damping function ƒ(x) is the first derivative of impedance function F(x) with respect to the state x

ƒ(x)=F′(x) (25)

Based on the spectral decomposition theorem [9, Chapter 7], the damping function has to be a non-zero value if it is a stable system. The impedance function is

y=F(x) (26)

From the equations (23), (24) and (25), the impedance function F(x) is the integral of damping function ƒ(x) over one specific operated domain x>0 as

F(x)=∫₀^{x}ƒ(x)dx (27)

Under the assumptions that F, g ∈ C¹ (R), F and g are odd functions of x, F(0)=0, F′(0)<0, F has single positive zero at x=α, and F increases monotonically to infinity for x≧α as x→∞, it follows that the Lienard system by equation (23) has exactly one limit cycle and it is stable. Comparing the equation (27) to the bifurcation point defined by the equation (21) or (22), the initial condition of the equation (27) is extended to an arbitrary setting as

F(x)=∫_{α}^{x}ƒ(x)dx (28)

where a∈R. We conclude that an adaptive-dynamic impedance function F(x) has the following properties:
1. The damping function is not a constant. At the interval,

α≦a

the impedance function F(x) is

F(x)<0

The derivative of function F(x)

F′(x)=ƒ(x)>0 (29)

This is a positive differential resistivity or simply PDR as defined by the equation (17) or (18), or,

F′(x)=ƒ(x)<0 (30)

this is a negative differential resistivity or simply NDR as defined by the equation (19) or (20) of which both are held simultaneously. It means that the impedance function F(x) has the negative and positive slopes at the interval α≦a.
2. Following the Lienard theorem [11, Page 253-260], [8, Chapter 10,11], [10, Chapter 8] and the correspondent theorems, corollaries and lemma, we can further conclude that one stabilized system which has at least one limit cycle, all solutions to the system by equation (23) converge to this limit cycle even asymptotically stable periodic closed orbit. In fact, this kind of system construction can be realized a stabilized system in Poincaré sense [11, Page 253-260], [8, Chapter 10,11], [7, Chapter 1,2,3,4], [2, Chapter 3].

### SUMMARY OF THE INVENTION

A first objective of the present invention is to provide a circuit which can guide an unpredictable voltage or current surge, such as static electricity and eddy current, into the circuit and let them dissipate in the circuit.

A second objective of the present invention is to provide a protection circuit to a DC power source to protect the load against any power surge.

A third objective of the present invention is to provide an energy discharge capacitor which can quickly dissipate the energy and the capacitor is useful to our inventive circuits.

### BRIEF DESCRIPTION OF THE DRAWINGS

FIG. 1 has shown a discharging circuit;

FIG. 2 has shown the circuit of FIG. 1 further comprising an orientation-guided device serially coupled with each other;

FIG. 3 has shown the structure of a PNDR-equipped capacitor which can be applied to the circuits shown in FIG. 1 and 2;

FIG. 4 has shown a parallel oscillator circuit;

FIG. 5 has shown a series oscillator circuit;

FIG. 6 has shown an eddy current generated by a moving (or changing) magnetic field intersecting a conductor, or vice-versa;

FIG. 7 has shown the circuits shown in FIG. 1 and 2 applied to the circuit shown in FIG. 6 for discharging the eddy current;

FIG. 8 has shown a circuit for protecting the power surge;

FIG. 9 has shown the circuit shown in FIG. 8 further comprising a switch for actively controlling the power source;

FIG. 10 has shown a fundamental clock running at a fixed frequency; and

FIG. 11 has shown a multi-frequency waveform by demonstrating the clock of FIG. 10 carried with broadband-frequency carriers.

### DESCRIPTION OF THE PREFERRED EMBODIMENT

The properties of the PDR and NDR have respectively been defined by the equations (8) and (9). A device is called PDR-equipped device if the device has PDR property. A device is called NDR-equipped device if the device has NDR property. A device is called PNDR-equipped device if it has PDR and NDR properties.

An assembly includes at least two devices serially coupled with each other and all the devices of the assembly are PDR-equipped devices then the assembly is called PDR-equipped assembly. An assembly includes at least two devices serially coupled with each other and all the devices of the assembly are NDR-equipped devices then the assembly is called NDR-equipped assembly. An assembly includes at least two devices serially coupled with each other and the assembly comprises a PDR-equipped device and a NDR-equipped device then the assembly is a PNDR-equipped assembly.

A PDR-equipped assembly can become PNDR-equipped assembly by adding at least one NDR-equipped device serially coupled with any one device of the assembly and no more PDR-equipped device is needed although the assembly is still allowed to be added more PDR-equipped device. A NDR-equipped assembly can become PNDR-equipped assembly by adding at least one PDR-equipped device serially coupled with any one device of the assembly and no more NDR-equipped device is needed although the assembly is still allowed to be added more NDR-equipped device. A PNDR-equipped assembly needs no more added PDR-equipped and NDR-equipped devices although the assembly is still allowed to be added more PDR-equipped and NDR-equipped devices. A PNDR-equipped assembly can be achieved by including all the possible ways explained above in the present invention. For example, if a loop originally includes five devices serially coupled with each other and if the loop comprises a PDR-equipped device and a NDR-equipped device of the five devices then the loop is for sure a PNDR-equipped loop. If all the five devices originally in the loop are PDR-equipped devices then at least a NDR-equipped device is needed to be added to serially couple with any one device of the loop to make the loop a PNDR-equipped loop. If all the five devices originally in the loop are NDR-equipped devices then at least a PDR-equipped device is needed to be added to serially couple with any one device of the loop to make the loop a PNDR-equipped loop. If the properties of the five devices are not known then a PDR-equipped device and a NDR-equipped device can still be serially coupled with any one device of the loop to make sure that the loop is a PNDR-equipped loop.

A statement is written as “an assembly comprises at least a device, at least a PDR-equipped device and at least a NDR-equipped device serially coupled with each other”. If the properties of the device or devices other than the PDR-equipped and NDR-equipped devices can be identified the device or devices can also be accounted as the PDR-equipped and NDR-equipped devices in the assembly. For example, if a statement is written as “a loop comprises a X, a Y, a Z, a PDR-equipped device and a NDR-equipped device serially coupled with each other”. The devices, which are the X, Y and Z, other than the PDR-equipped device and NDR-equipped device in the assembly can also be identified to have PDR or NDR property or even both properties, and the identified device or devices can be accounted as the PDR-equipped and NDR-equipped devices in the loop. For example, if the X has been identified to have PDR property then the loop becomes to comprise a X, Y, Z and a NDR-equipped device serially coupled with each other. If the Y has been identified to have NDR property then the loop becomes to comprise a X, Y, Z and a PDR-equipped device serially coupled with each other. If the Y has been identified to have NDR property and the Z has been identified to have PDR property then the loop becomes to comprise a X, Y, Z serially coupled with each other. The statement shown as “a loop comprises a X, a Y, a Z, a PDR-equipped device and a NDR-equipped device serially coupled with each other” has revealed: (1)the loop is a PNDR-equipped loop, (2) and the device or devices, which are X, Y and Z in the loop, other than the PDR-equipped device and a NDR-equipped device can be accounted as the PDR-equipped device and a NDR-equipped device. The present invention includes all the possible ways to make an assembly a PNDR-equipped assembly. A transmission line coupling the devices in the loop can be accounted for a device in the loop and its property could be identified. The present invention is not limited to any particular way to make an assembly a PNDR-equipped assembly.

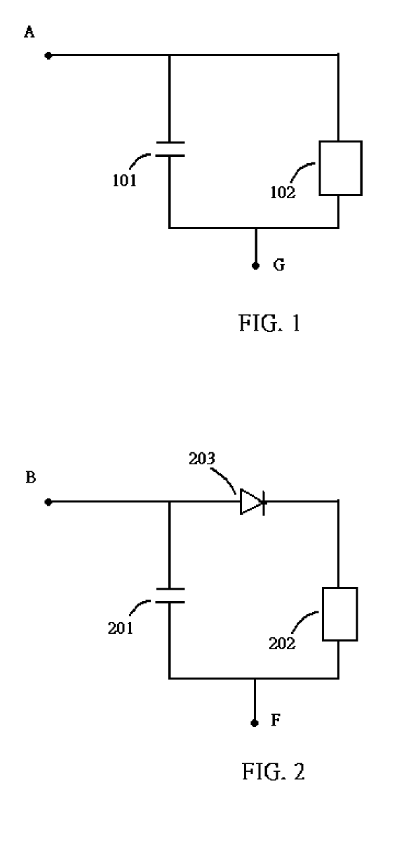

FIG. 1 has shown that a loop comprises a capacitor 101 and a NDR-equipped device 102 serially coupled with each other. A point A stands for any one point between a terminal of the capacitor 101 and a terminal of the NDR-equipped device 102 and a point G stands for any one point between the other terminal of the capacitor 101 and the other terminal of the NDR-equipped device 102. Either point A or G can be used as input and the other point A or G can couple to the ground or let it floating.

The loop shown in FIG. 1 can further comprise an orientation-guided device for keeping the current flowing only in one direction in the loop. For example, the orientation-guided device can be a diode or inductor, and the present invention is not limited to any particular orientation-guided device. A diode is used as the orientation-guided device in the embodiment of FIG. 2. FIG. 2 has shown that a loop includes a capacitor 201, a diode 203 and a NDR-equipped device 202 serially coupled with each other. And a point, which is marked as B, between a terminal of the capacitor 201 and the input terminal of the diode 203 is for input. The other point, which is marked as F, obtained by electrically connecting the other terminal of the capacitor 201 with a terminal of the NDR-equipped device 202 can couple to the ground or let it floating.

The electrodes of a capacitor usually have a relatively bigger area than an area of a media current flows thru and the current flows thru a capacitor leading the voltage, which makes a kind of attraction to the outside voltage or current surge. Checking FIG. 1 first, when an inrush voltage or current appears at point A the capacitor 101 is charged and a current flowing thru the NDR-equipped device 102 generates a voltage difference on the device 102. The voltage difference will generate more attraction to the outside inrush power so that the outside inrush power can be much more easiler pulled into the loop. Now checking FIG. 2, when an inrush voltage or current appears at point B the capacitor 201 is charged high enough to conduct the diode 203 and the voltage difference generated by a current flowing thru the NDR-equipped device 202 will generate attraction to the inrush power so that the outside inrush power can be much more easier pulled into the loop. The orientation-guided device in FIG. 2 is for converting the outside disorderly power into a current flowing in one direction in the loop. The capacitors shown in FIGS. 1 and 2 can be a type of energy discharge capacitor which not only stores energy but also dissipates the power. The type of energy discharge capacitor used in both loops can dissipate the power flowing in both loops. The energy discharge capacitor can be easily found in the market, for example, an USA company Norfolk Capacitors Limited makes this capacitor. The present invention is not limited to any particular capacitor. The diode 203 is better by using Zenor diode for being capable of outputting larger current when it is conducting.

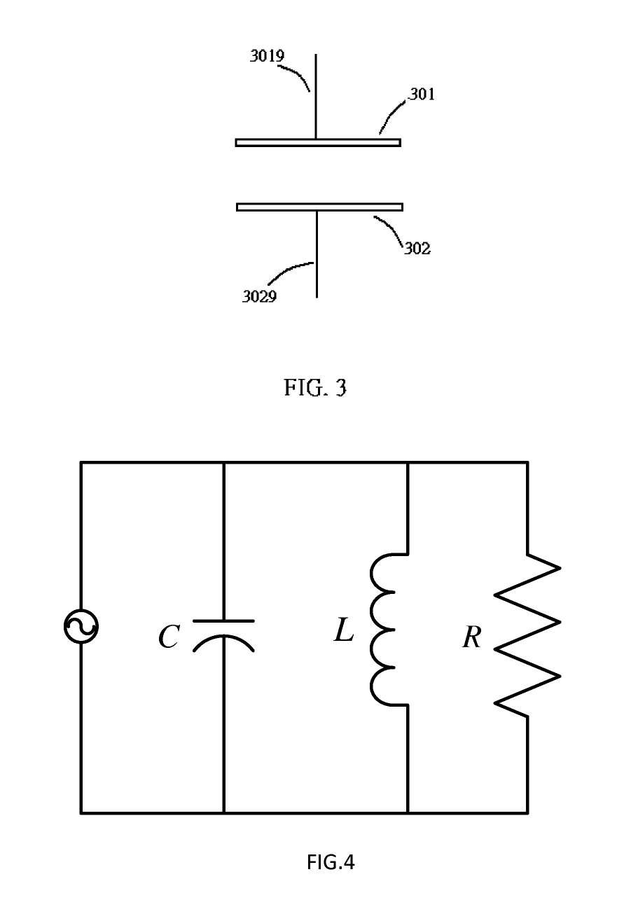

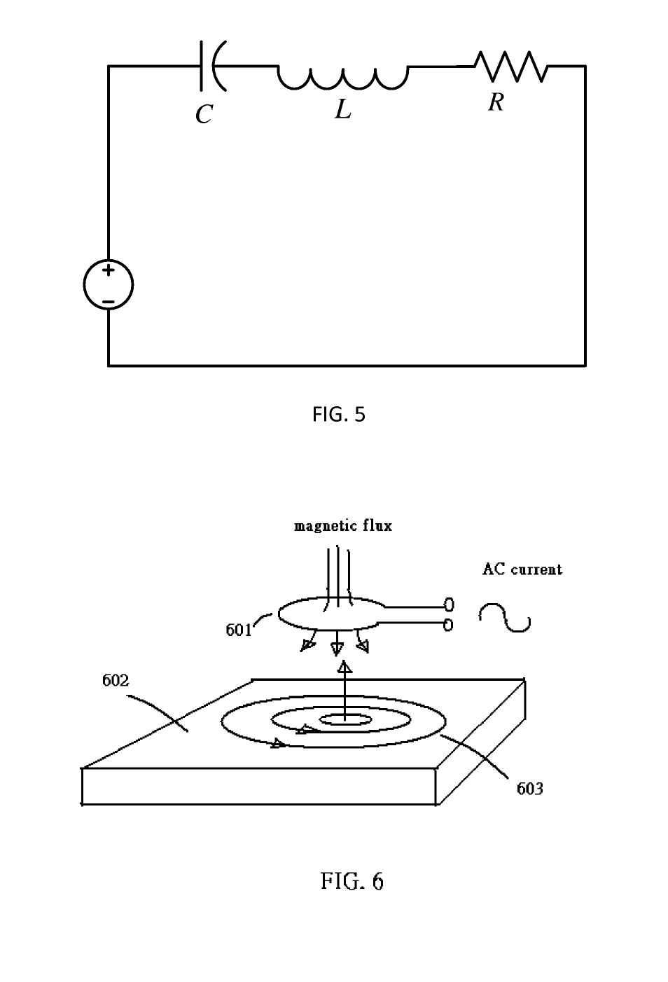

FIG. 3 has shown an inventive energy discharge capacitor which can also be called PNDR-equipped capacitor. The PNDR-equipped capacitor can be applied to the circuits of FIGS. 1 and 2, and it can charge and discharge in a very effective way. The PNDR-equipped capacitor shown in FIG. 3 includes a first conductive electrode (or plate) 301 coupled with a first conductive terminal 3019 and a second conductive electrode 302 coupled with a second conductive terminal 3029. The two conductive terminals 3019 and 3029 are used for electrically connecting the outside circuits. The first conductive electrode 301 has PDR property and the second conductive electrode 302 has NDR property, or both the first conductive electrode 301 and its connected first conductive terminal 3019 have PDR properties and both the second conductive electrode 302 and its connected second conductive terminal 3029 have NDR properties, or the first conductive terminal 3019 instead of the first conductive electrode 301 has PDR property and the second conductive terminal 3029 instead of the second conductive electrode 302 has NDR property. The space between two electrodes 301 and 302 can be filled by dielectric material 303 which should be a good frequency-responding material. The present invention is not limited to any particular shape of the electrode made up the capacitor.

An electrode having PDR property can be called PDR-equipped electrode and an electrode having NDR property can be called NDR-equipped electrode in the present invention. The present invention is not limited to any particular dielectric material, for example, the ferroelectric material is a good dielectric material. A serially coupled PDR- and NDR-equipped devices perform damping function which can dissipate the power in the form of frequency shifting and has broader frequency band and better frequency response, which has been explained in the background section of the present invention.

When the PNDR-equipped capacitor connected to an alternating current (AC) voltage source, the capacitor is repeately charged and discharged. The charge of the capacitor can be quickly dissipated due to PNDR-equipped damper. The PNDR-equipped capacitor can be used in the circuits of FIGS. 1 and 2 to help dissipate the current flowing the loops.

The circuits shown in FIGS. 1 and 2 can be used to quickly discharge the unpredictable, inrush voltage or current surge such as static electricity and eddy current phenomenon. For example, they can be used as Electro-Static Discharge (or ESD) for discharging a high and an unpredictable electro-static voltage surge. The circuits shown in FIG. 1 and 2 can also be used to discharge the so-called eddy current.

The eddy current is caused when a moving (or changing) magnetic field intersects a conductor, or vice-versa. The relative motion causes a circulating flow of electrons, or current, within the conductor. Eddy current transform useful forms of energy, such as kinetic energy, into heat. In many devices, this Joule heat reduces efficiency of iron-core transformers and electric motors and other devices that use changing magnetic fields. FIG. 6 has shown a simplified scheme in which an AC current is applied on a coil 601 and an eddy current 603 is generated on a conductor plate 602. The circuit shown in FIGS. 1 or 2 can be applied to solve the eddy current shown in FIG. 6. Either the point A or G of the loop of FIG. 1 electrically connects a surface of the conductor plate 602 where the eddy current occurs and the other point A or G of the loop electrically connects the other surface of the conductor plate 602 without eddy current or the ground if possible. The point B of the loop of FIG. 2 electrically connects a surface of the conductor plate 602 where the eddy current occurs and the other point F electrically connects the other surface of the conductor plate 602 without eddy current or the ground if possible.

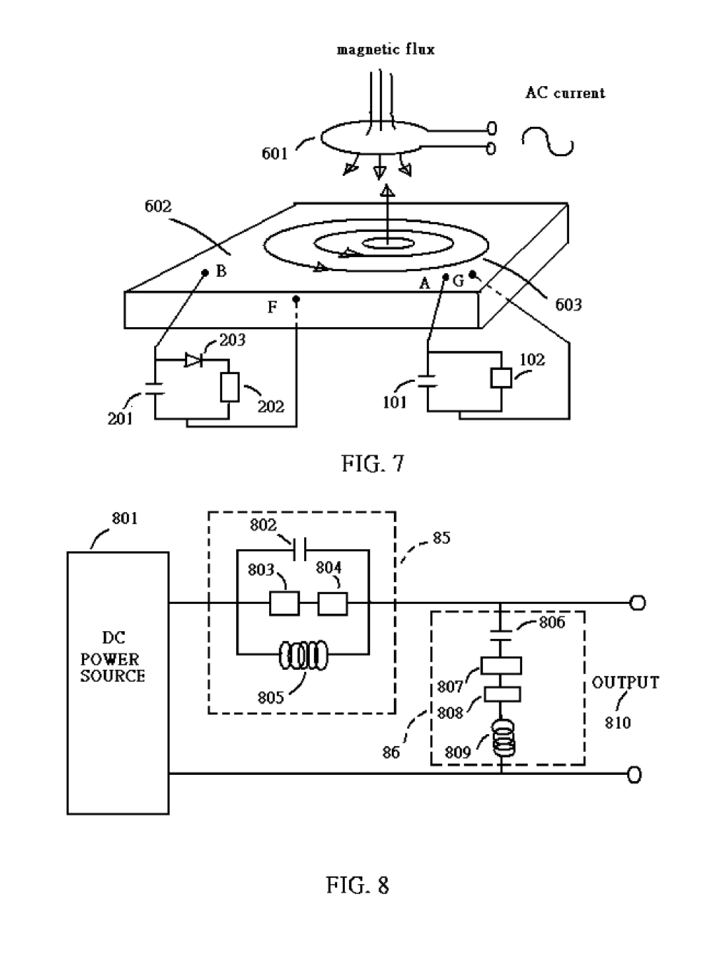

FIG. 7 has shown that both the circuits shown in FIGS. 1 and 2 respectively electrically connect the conductor plate 602 shown in FIG. 6. FIG. 7 has shown that the point A shown in FIG. 1 electrically connects the surface where eddy current occurs and the other point G electrically connects the other side of the conductor plate 602 without eddy current. FIG. 7 has also shown that the point B shown in FIG. 2 electrically connects the surface where eddy current occurs and the point F electrically connects the other side of the conductor plate 602 without eddy current.

A circuit for protecting power surge is shown in FIG. 8. A loop comprises a DC power source 801, a parallel oscillator subsystem marked by a dotted block 85 and a serial oscillator subsystem marked by another dotted block 86 serially coupled with each other. The two ends of the serial oscillator subsystem 86 are for output 810. The parallel oscillator subsystem 85 comprises a first capacitor 802, a first inductor 805, at least a PDR-equipped device shown as a first PDR-equipped device 803 and at least NDR-equipped device shown as a first NDR-equipped device 804 in which the first PDR-equipped device 803 couples in series with the first NDR-equipped device 804, and the first capacitor 802, the first inductor 805 and the serially coupled first PDR- and first NDR-equipped devices 803, 804 are in parallel. The serial oscillator subsystem 86 comprises a second capacitor 806, at least a PDR-equipped device shown as a second PDR-equipped device 807, at least a NDR-equipped device shown as a second NDR-equipped device 808 and a second inductor 809 serially coupled with each other. The two ends of the series oscillator subsystem 86 are for output 810.

When a DC power without significant frequency comes from the DC power source 801 the DC current will choose to go thru the first inductor 805 because its lower impedance compared to the first PDR- and NDR-equipped devices 803, 804 then the current is straight sent to the output 810. When a DC power surge with a significant frequency change the current from the power source will then choose the path of the first PDR-equipped and the first NDR-equipped devices 803, 804. The first PDR-equipped and the first NDR-equipped devices 803, 804 will dissipate portion of the DC power surge and generate new frequencies which will work with the first capacitor 802 and the first inductor 805 to induce AC. At this point, the DC power from the power source 801 can be viewed as divided into AC and DC. The AC will choose to go thru the serial oscillator subsystem 86 because the impedance of the serial oscillator subsystem 86 is usually smaller than that of the load, and the DC power can not go thru the capacitor 806 of the serial oscillator subsystem 86 so that the DC will go to the output 810. The AC will be dissipated further thru the serial oscillator subsystem 86 in the loop containing the parallel oscillator subsystem 85 and serial oscillator subsystem 86. The concept is that a significant inrush surge from the DC power source 801 will be divided into AC and DC in which AC will be dissipated in a loop containing the parallel oscillator subsystem 85 and serial oscillator subsystem 86 and the safe DC is sent to the output 810. Our inventive PNDR-equipped capacitor can be applied to the circuit.

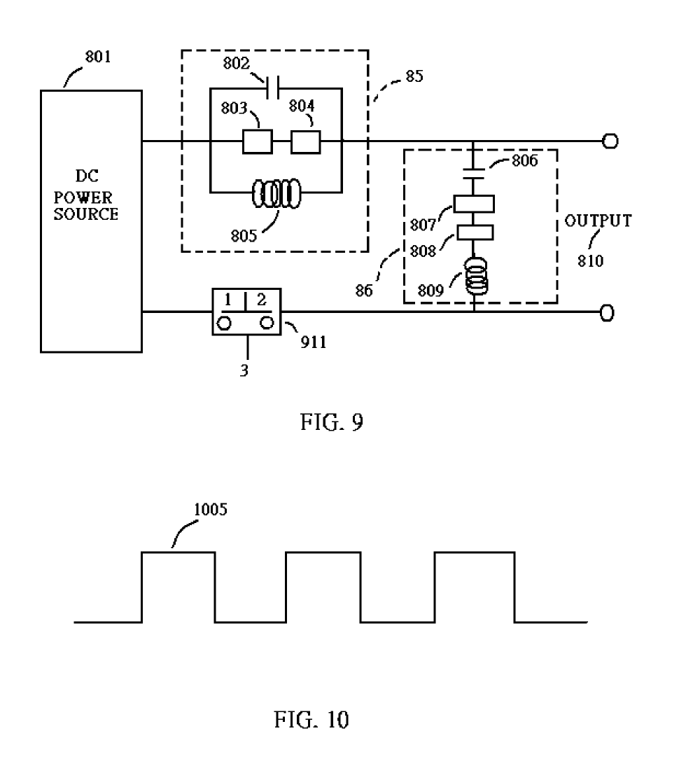

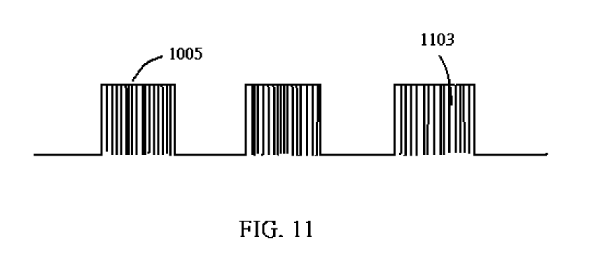

The circuit shown in FIG. 8 can further comprise a switch to actively control the power source. FIG. 9 has shown a switch 911 is included in the loop containing the parallel and serial oscillator subsystems 85 and 86 and the switch 911, the parallel oscillator subsystem 85 and the serial oscillator subsystem 86 are serially coupled with each other. The switch 911 comprises three terminals respectively marked as 1,2 and 3 in the drawing. The terminal 3 can receive input for controlling the electrical connection and disconnection of the terminals 1 and 2, and the input to the terminal 3 can be in the form of multi-frequency waveform. The multi-frequency waveform are defined by equations (9.1) and (9.2). FIG. 10 has shown a fundamental clock running at a fixed frequency. FIG. 11 has shown the fundamental clock 1005 of FIG. 10 carried with broadband-frequency carriers 1103, which is called multi-frequency waveform. The fundamental frequency shown in FIG. 10 doesn't have to be a fixed frequency and a fixed waveform although a fixed frequency and waveform 1005 have been demonstrated in FIG. 10. For another example, the input on the terminal 3 can be a fed-back signal from the load.

### REFERENCES

[1] Tom M. Apostol. Mathematical Analysis. Addison-Wesley Publishing Company., http://www.aw-bc.com/, 2nd edition, 1975.
[2] V. I. Arnold. Geometrical Methods in the Theory of Ordinary Differential Equations. Springer-Verlag., http://www.springer-ny.com/, 2nd edition, 1988.
[3] E. T. Copson. An introduction to the theory of functions of a complex variable. Oxford University Press., http://www.amazon.com/, 4th edition, 1948.
[4] Theodore Van Duzer and Charles W. Turner. Principles of Superconductive Devices and Circuits. Prentice Hall PTR., http://www.phptr.com, 2nd edition, 1999.
[5] G. N. Watson E. T. Whittaker. A Course of Modern Analysis. Cambridge Mathematical Library., http://www.cambridge.org, 4th edition, 1927.
[6] R. Wong F. Cuker. The Collected Papers of Stephen Smale., volume 3. Singapore University Press., http://www.worldscibooks.com/mathematics, 2000.
[7] John Guckenheimer and Philip Holmes. Nonlinear Oscillations, Dynamical Systems, and Bifurcations of Vector Fields. Springer-Verlag., http://www.springer-ny.com/, 1997.
[8] Morris W. Hirsh and Stephen Smale. Differential Equations, Dynamical Systems and Linear Algebra. Academic Press., http://www.academicpress.com/, 1974.
[9] Thomas J. R. Hughes. Jerrold E. Marsden. Mathematical Foundations of Elasticity. Prentice-Hall, Inc., http://www.doverpublications.com/, 1984.
[10] D. W. Jordan and Peter Smith. Nonlinear Ordinary Differential Equations. Oxford University Press., http://www.oup.co.uk/academic/, 3rd edition, 1999.
[11] Lawrence Perko. Differential Equations and Dynamical Systems. Springer-Verlag, New York, Inc., http://www.springer-ny.com, 3rd edition, 2000.
[12] Steven H. Strogatz. Nonlinear Dynamics and Chaos: With Applications to Physics, Biology, Chemistry and Engineering. Perseus Books Group., http://www.westviewpress.com, 1st edition, 2001.
[13] Matthew Sands. WRichard P. Feynman, Robert B. Leighton. Feynman Lectures On Physics: The Complete And Definitive Issue., volume 3. Addison Wesley Publishing Company., http://www.aw-bc.com, 2nd edition, 1964.
[14] A. David Wunsch. Complex Variables with Applications. Addison-Wesley Publishing Company Inc., http://www.aw-bc.com/, 1983.
[15] Ling Ye and Xiangyang Peng. Selected Topics in Condensed Matter Physics. Fudan University Press., http://www.fudanpress.com, 2003.

What is claimed is:

1. A capacitor, comprising:
a first conductive electrode having PDR property;
a second conductive electrode having NDR property, and
a dielectric material, wherein the dielectric material is placed between the first and second electrodes.

2. A loop comprising:
a capacitor; and
a NDR-equipped device coupled with the capacitor, wherein any one point between a terminal of the capacitor and a terminal of the NDR-equipped device is for input, and any one point between the other terminal of the capacitor and the other terminal of the NDR-equipped device can couple to the ground or let it floating.

3. The loop of claim 2, wherein the loop further comprises an orientation-guided device serially coupled with each other, and a point between a terminal of the capacitor and the input terminal of the orientation-guided device is for input, and any one point between the other terminal of the capacitor and a terminal of the NDR-equipped device can couple to the ground or let it floating.

4. The loop of claim 3, wherein the orientation-guided device is a diode.

5. The loop of claim 3, wherein the orientation-guided device is an inductor.

6. The loop of claim 2, wherein the input point electrically connects a surface of a conductor where eddy current occurs, and any one point between the other terminal of the capacitor and the other terminal of the NDR-equipped device electrically connects another surface of the conductor without eddy current or to the ground.

7. The loop of claim 3, wherein the input point electrically connects a surface of a conductor where eddy current occurs and any one point between the other terminal of the capacitor and a terminal of the NDR-equipped device electrically connects another surface of the conductor without eddy current or to the ground.

8. The loop of claim 2, wherein the capacitor is the capacitor of claim 1.

9. The loop of claim 3, wherein the capacitor is the capacitor of claim 1.

10. A loop including:
a power source, a parallel oscillator subsystem and a serial oscillator subsystem serially coupled with each other, wherein the parallel oscillator subsystem includes a first inductor, a first capacitor, a first PDR-equipped device and a first NDR-equipped devices in which the first PDR-equipped device and the first NDR-equipped device are serially coupled with each other, and the first inductor, the first capacitor and the serially coupled PDR- and NDR-equipped devices are electrically connected in parallel, and wherein the serial oscillator subsystem includes a second inductor, a second capacitor, a second PDR-equipped device and a second NDR-equipped device serially coupled with each other, and the two ends of the serial oscillator subsystem are for output.

11. The loop of claim 10 further including a switch for actively controlling the power, wherein the switch, the parallel oscillator subsystem and serial oscillator subsystem are serially coupled with each other, and the switch comprises three terminals in which an input to a terminal can control the electrical connection or disconnection of the other two terminals.

12. The loop of claim 11, wherein the input to the terminal controlling the electrical connection or disconnection of the other two terminals is in the form of multi-frequency waveform.

13. The capacitor of claim 1 further comprising a first and a second conductive terminals respectively coupled to the first and second conductive electrodes for electrically connecting the outside circuits.

14. The capacitor of claim 13, wherein the first conductive terminal instead of the first conductive electrode has PDR property and the second conductive terminal instead of the second conductive electrode has NDR property.

15. The capacitor of claim 13, wherein the first conductive terminal has PDR property and the second conductive terminal has NDR property.

16. The loop of claim 10, wherein the first and second capacitors are the capacitor of claim 1.

17. The loop of claim 10, wherein the second PDR-equipped device is the second capacitor and/or the second inductor.

18. The loop of claim 10, wherein the second NDR-equipped device is the second capacitor and/or the second inductor.
